(19) United States
(12) Patent Application Publication
(10) Pub. No.: US 2012/0307289 A1
(43) Pub. Date: Dec. 6, 2012

(54) PRINTER IDENTIFICATION USING CUSTOM SOUNDS

(75) Inventor: Todd W. Ritland, San Francisco, CA (US)

(73) Assignee: APPLE INC., Cupertino, CA (US)

(21) Appl. No.: 13/153,232

(22) Filed: Jun. 3, 2011

(51) Int. Cl. G06F 15/00

(52) U.S. Cl. 358/1.15

(57) ABSTRACT

The disclosed embodiments provide a system that facilitates use of a printing system. The system includes a print server and a printer. The print server may identify a custom sound associated with a user of the printing system and provide the custom sound to the printer. The printer may then generate the custom sound to facilitate identification of the printer by the user. For example, the printer may generate the custom sound during receipt of a print job by the printer, completion of the print job, a job error associated with the print job, and/or use of the printing system by the user.

### BACKGROUND

1. Field

The present embodiments relate to printers for computer systems. More specifically, the present embodiments relate to techniques for facilitating the identification of printers by generating custom sounds at the printers.

2. Related Art

Printing may facilitate numerous aspects of an organization's activities. For example, documents may be printed within the organization for design, marketing, accounting, review, recordkeeping, planning, and/or notification purposes. However, significant costs may be incurred by the organization in implementing and providing print technology, including costs associated with the purchase of printing hardware and supplies as well as costs associated with maintenance and configuration of computers and printers within the organization's printing infrastructure.

In addition, the centralized management of printing resources within an organization's printing infrastructure may cause problems with identifying and/or locating the printing resources. For example, the printing infrastructure may group a large number of printers into a printing pool that is presented as a single logical printer to users of the printing infrastructure. Print jobs may then be sent to different physical printers in the printing pool based on load balancing, availability, printer capabilities, and/or other attributes associated with the printing pool. As a result, the printing infrastructure may not provide information that allows the users to identify and/or locate the physical printers to which the users' print jobs are sent.

Hence, use of printing infrastructures may be facilitated by mechanisms that enable the identification of printers within the printing infrastructures.

### SUMMARY

The disclosed embodiments provide a system that facilitates use of a printing system. The system includes a print server and a printer. The print server may identify a custom sound associated with a user of the printing system and provide the custom sound to the printer. The printer may then generate the custom sound to facilitate identification of the printer by the user. For example, the printer may generate the custom sound during receipt of a print job by the printer, completion of the print job, a job error associated with the print job, and/or use of the printing system by the user.

In some embodiments, identifying the custom sound involves at least one of:

(i) obtaining a selection of the custom sound from the user;

(ii) obtaining the custom sound from user data for the user; and

(iii) obtaining an identifier for the custom sound.

In some embodiments, the identifier is associated with at least one of a print job, the user, a device, a document to be printed, and a group.

In some embodiments, providing the custom sound to the printer involves at least one of providing audio data for the custom sound to the printer, and providing an identifier for the custom sound to the printer.

In some embodiments, the audio data for the custom sound is provided by at least one of a print server in the printing system, a device in the printing system, storage on the printer, and a network associated with the printing system.

In some embodiments, the custom sound includes a ringtone.

### BRIEF DESCRIPTION OF THE FIGURES

FIG. 1 shows a printing system in accordance with an embodiment.

FIG. 2 shows a system for facilitating use of a printing system in accordance with an embodiment.

FIG. 3 shows a flowchart illustrating the process of facilitating use of a printing system in accordance with an embodiment.

FIG. 4 shows a flowchart illustrating the process of facilitating use of a printer in accordance with an embodiment.

FIG. 5 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

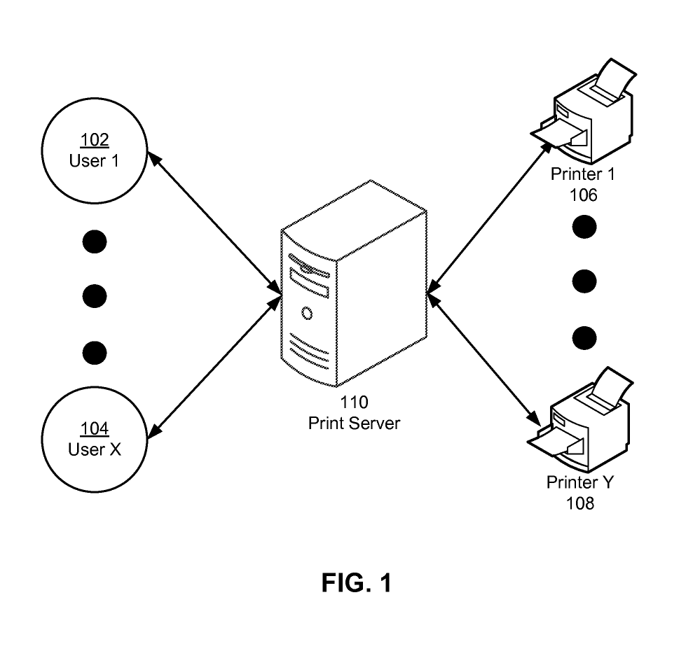

The disclosed embodiments provide a method and system for facilitating use of a printing system. As shown in FIG. 1, the printing system includes a print server 110 and one or more printers (e.g., printer 1 106, printer y 108) connected to print server 110. The printers may correspond to network printers that are connected to print server 110 using a wired or wireless network connection. Alternatively, one or more printers may connect to print server 110 and/or other print servers in the printing system as local peripherals using one or more printer cables and/or one or more ports (e.g., parallel ports, serial ports, Universal Serial Bus (USB) ports).

Print server 110 may process and configure requests for print jobs from one or more users (e.g., user 1 102, user x 104). The users may be associated with access rights to one or more printers connected to print server 110. For example, the users may correspond to members of an organization (e.g., business, school, company, etc.) with user accounts that enable use of one or more printers connected to print server 110.

Upon receiving a request for a print job, print server 110 may send the request to the appropriate printer, which executes the print job using settings provided by the user requesting the print job. For example, the user may select a document to be printed and one or more job options associated with printing the document. The job options may include a number of copies, a number of printing sides (e.g., single- or double-sided), collation, stapling, an ink type (e.g., black-and-white, color), a paper size (e.g., A4, letter), a paper type (e.g., glossy, matte, bond, colored), a page orientation, a hold time (e.g., one hour, indefinitely), and/or a printing range (e.g., page range, selection).

However, centralized management of printers in the printing system may cause problems with user identification and/or location of the printers. For example, the printing system may contain large numbers of printers with nondescript names (e.g., “Printer 1”) and/or locations (e.g., “Building 3”). As a result, a user may be unable to uniquely identify and/or locate the printer to which his/her print job is assigned using only the printer's name and/or location as specified by the printing system. Instead, the user may be required to manually locate the print job and/or printer by examining the pages outputted by various printers in the printing system.

Moreover, the printing system may group multiple physical printers into a printing pool that is presented as a single logical printer to the user. Print jobs may be distributed among printers in the printing pool based on load balancing, availability, printer capabilities (e.g., color, black-and-white, resolution, etc.), and/or other attributes associated with the printer pool. The printing pool may thus reduce user wait times for print jobs and/or enable the management of a set of physical printers from the same logical printer and/or print server (e.g., print server 110). Conversely, the lack of distinction between physical printers in the printer pool may prevent the user from obtaining information from the printing system that allows the user to identify and/or locate the physical printer to which his/her print job was sent.

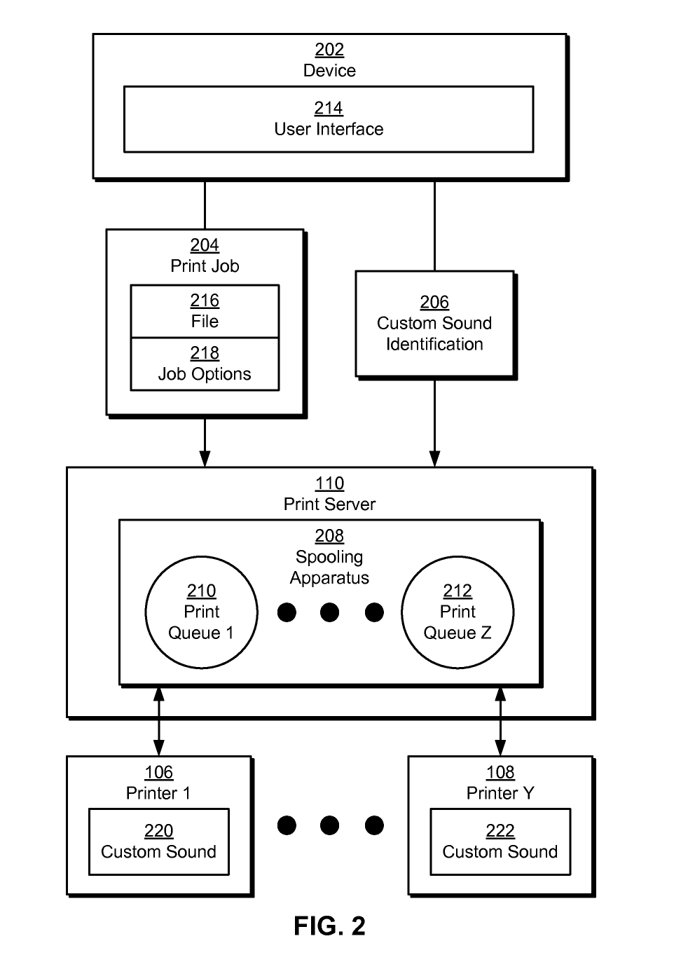

In one or more embodiments, print server 110 and/or other components in the printing system include functionality to facilitate the identification of printers in the printing system. As discussed in further detail below with respect to FIG. 2, print server 110 may identify a custom sound associated with a user of the printing system and/or a document to be printed by the printing system. For example, print server 110 may identify a ringtone associated with the user from a ringtone selection provided by the user, user data for the user, and/or an identifier for the ringtone.

Next, print server 110 may provide the custom sound to a printer (e.g., printer 1 106, printer y 108) in the printing system. For example, print server 110 may provide audio data (e.g., an audio file) for the custom sound and/or an identifier for the custom sound to the printer. The printer may then generate the custom sound to facilitate identification of the printer by the user. For example, the printer may play the audio data for the custom sound to allow the user to locate a print job in the printing system. As a result, the printer may generate the custom sound upon receiving the print job, completing the print job, and/or detecting a job error associated with the print job.

The printer may also generate the custom sound even if the user is not expecting a print job from the printer. For example, the printer may generate the custom sound during configuration of a user account for the user with the printing system to enable the user to identify his/her default printer in the printing system. In other words, the custom sound may allow identification of the printer during general use of the printing system by the user, regardless of naming conventions and/or logical groupings (e.g., printing pools) associated with the printer and/or printing system.

FIG. 2 shows a system for facilitating use of a printing system in accordance with an embodiment. As described above, the system may be provided by print server 110 and/or other components (e.g., computer systems, print servers) associated with the printing system. In addition, user access to the printing system may be enabled by a device 202 associated with the user. For example, device 202 may correspond to a laptop computer, personal computer, mobile phone, tablet computer, and/or other network-enabled electronic device to which the user has access. In turn, device 202 may communicate with print server 110 using HyperText Transfer Protocol (HTTP), Internet Printing Protocol (IPP), Line Printer Daemon (LPD) protocol, and/or another network protocol associated with communication in a printing system.

To use the printing system, the user may interact with a user interface 214 (e.g., graphical user interface (GUI), command line interface (CLI), etc.) associated with device 202. For example, the user may interact with a wizard on device 202 to set up a print job 204 in the printing system. Within the wizard, the user may select a file 216 (e.g., document) to be printed, as well as one or more job options 218 (e.g., number of pages, number of copies, collating, stapling, printing sides, ink type, paper size, etc.) associated with print job 204.

To execute print job 204, device 202 may transmit print job 204 to print server 110, where print job 204 is placed into a print queue (e.g., print queue 1 210, print queue z 212) by a spooling apparatus 208. For example, spooling apparatus 208 may assign print job 204 to a specific printer (e.g., printer 1 106, printer y 108) by placing print job 204 in the print queue for the printer. The printer may then retrieve print job 204 from the print queue once the printer is ready to start print job 204. Alternatively, spooling apparatus 208 may place print job 204 into a print queue for a printing pool containing multiple physical printers. Print job 204 may then be processed by a printer in the printing pool based on the load, availability, printer characteristics, and/or other attributes of printers in the printing pool.

In addition, device 202 and/or print server 110 may allow the user to identify the printer to which print job 204 was sent by generating a custom sound 220-222 associated (e.g., recognized by) with the user and/or file 216 at the printer. As shown in FIG. 2, a custom sound identification 206 may be provided to print server 110 by device 202. For example, device 202 may transmit custom sound identification 206 with print job 204 to print server 110, or device 202 may transmit custom sound identification 206 independently from print job 204 to print server 110.

In one or more embodiments, custom sound identification 206 is obtained from a selection of a custom sound (e.g., custom sound 220-222) from the user, user data for the user, and/or an identifier for the custom sound. For example, the user may select a ringtone (e.g., series of notes, audio recording, etc.) that he/she recognizes during the creation of print job 204 within user interface 214. Alternatively, the ringtone may be associated with the file type and/or contents of file 216 and/or specified within a user profile for the user on the printing system and/or another information system that is linked to the printing system. Finally, an identifier (e.g., universally unique identifier (UUID)) for the ringtone may be previously provided to print server 110 during creation of a user account for the user and/or a preceding print job by the user on the printing system. Print server 110 may associate the identifier with the user, device 202, a group to which the user belongs, file 216, and/or a print job with which the identifier was received and use the identifier to identify the ringtone during the processing and/or scheduling of subsequent print jobs (e.g., print job 204) from the user.

Print server 110 may then use custom sound identification 206 to provide the custom sound to the printer. First, print server 110 may use custom sound identification 206 to retrieve audio data (e.g., an audio file) for the custom sound from print server 110, device 202, and/or a network (e.g., computer network, storage area network, etc.) associated with the printing system. Print server 110 may then provide the audio data to the printer to allow the printer to generate the custom sound by playing the audio data on a speaker.

On the other hand, print server 110 may provide the identifier for the custom sound to the printer to enable retrieval of the audio data by the printer. For example, audio data for the custom sound may be stored in each printer used by the user. As a result, print server 110 may transmit a UUID for the custom sound and print job 204 to the printer. The printer may use the UUID to retrieve the audio data from storage on the printer, print server 110, device 202, and/or the network and play the audio data during receipt of print job 204, completion of print job 204, and/or a job error associated with print job 204. Because the custom sound is recognized by the user, the custom sound may allow the user to efficiently and/or effectively identify the printer and/or retrieve the print job from the printer.

Device 202 and/or print server 110 may additionally facilitate the identification of printers during use of the printing system that is not related to the creation and/or processing of print job 204 and/or other print jobs in the printing system. For example, the user may interact with user interface 214 to select a default printer to which the user's print jobs are sent. The user may then select a ringtone representing the default printer for the user. To allow the user to identify and/or locate the default printer, device 202 and/or print server 110 may send audio data and/or an identifier for the ringtone to the default printer, and the default printer may generate the ringtone. Consequently, the custom sound may be generated before, during, and/or after printing of file 216 by the printing system.

Those skilled in the art will appreciate that the system of FIG. 2 may be implemented in a variety of ways. For example, the user may use a variety of devices (e.g., device 202) to interact with user interface 214 and/or communicate with print server 110. Similarly, the user may send print jobs and/or custom sound identifications to multiple print servers to enable the identification and/or use of different sets of printers connected to the print servers. Finally, the user may interact directly with user interface 214 on print server 110 if print server 110 is provided by a personal computer (e.g., laptop computer, desktop computer) to which the user has access.

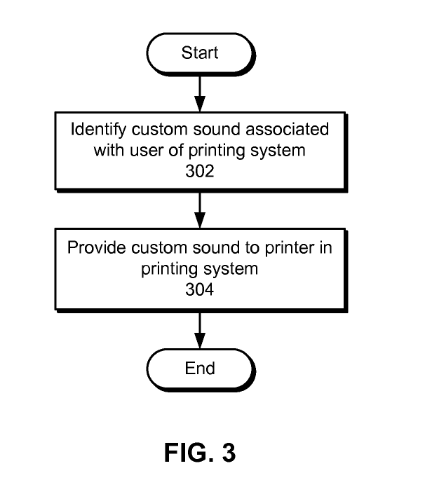

FIG. 3 shows a flowchart illustrating the process of facilitating use of a printing system in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

First, a custom sound associated with a user of the printing system is identified (operation 302). The custom sound may be identified by obtaining a selection of the custom sound from the user, obtaining the custom sound from user data for the user, and/or obtaining an identifier for the custom sound. The identifier may additionally be associated with a print job, the user, a device in the printing system, a document to be printed, and/or a group. For example, the identifier may be associated with the user's mobile phone so that print jobs from the mobile phone are associated with the custom sound by the printing system. Alternatively, the identifier may be associated with a file type and/or the contents of the document so that the custom sound is linked to a creator of the document and/or an entity associated with the contents of the document.

Next, the custom sound is provided to a printer in the printing system (operation 304), where the custom sound is generated to facilitate identification of the printer by the user. For example, the custom sound may correspond to a ringtone that is recognized by the user. Audio data and/or an identifier for the custom sound may be provided to the printer by a print server in the printing system, a device in the printing system, storage on the printer, and/or a network associated with the printing system. The printer may then play the audio data during receipt of a print job from the user, completion of the print job, a job error associated with the print job, and/or use of the printing system by the user.

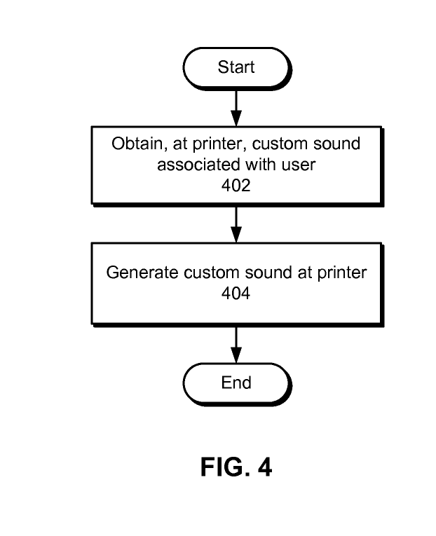

FIG. 4 shows a flowchart illustrating the process of facilitating use of a printer in accordance with an embodiment. In one or more embodiments, one or more of the steps may be omitted, repeated, and/or performed in a different order. Accordingly, the specific arrangement of steps shown in FIG. 4 should not be construed as limiting the scope of the technique.

Initially, a custom sound associated with a user is obtained at the printer (operation 402). The custom sound may be obtained with a print job from the user and/or obtained independently from the print job. In addition, the custom sound may be obtained by receiving audio data and/or an identifier for the custom sound. For example, the identifier and/or audio data may be received from a print server, a device (e.g., mobile phone, tablet computer, personal computer), storage on the printer, a document to be printed using the print job, and/or a network associated with the printer. If the audio data is received, receipt of the identifier may be optional because the audio data may correspond to the custom sound. Similarly, if the identifier is received, receipt of the audio data may be optional because the identifier may enable the retrieval of the audio data from the print server, device, printer storage, and/or network.

Regardless of the method of receipt, the custom sound is generated at the printer (operation 404). For example, the printer may generate the custom sound during receipt of a print job, completion of the print job, a job error associated with the print job, and/or use of the printing system by the user (e.g., prior to creation of the print job). As a result, the custom sound may correspond to an audio notification regarding the location and/or identity of the printer and/or the status of the print job to the user.

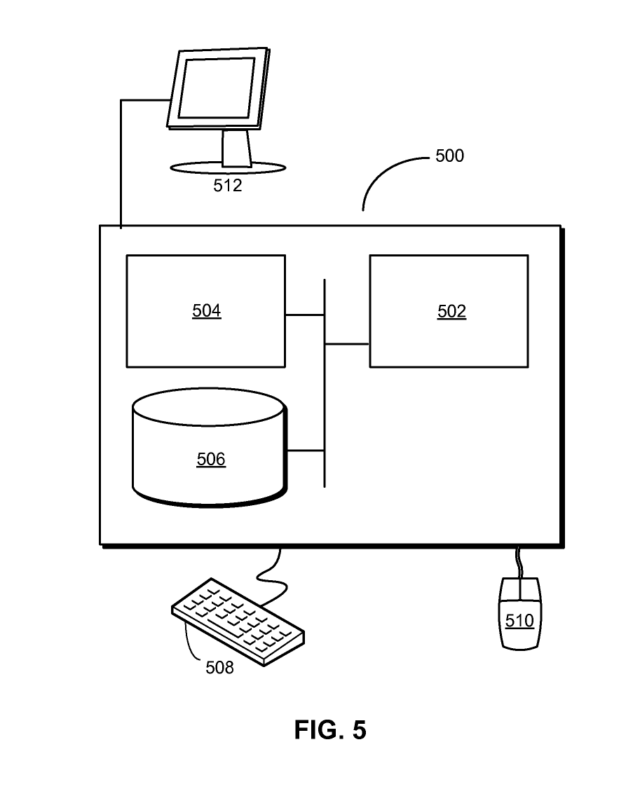

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating use of a printing system. The system may include a print server and a printer. The print server may identify a custom sound associated with a user of the printing system and provide the custom sound to a printer in the printing system. The printer may then generate the custom sound to facilitate identification of the printer by the user. For example, the printer may generate the custom sound during receipt of a print job by the printer, completion of the print job, a job error associated with the print job, and/or use of the printing system by the user.

In addition, one or more components of computer system 500 may be remotely located and connected to the other components over a network. Portions of the present embodiments (e.g., print server, printer, etc.) may also be located on different nodes of a distributed system that implements the embodiments. For example, the present embodiments may be implemented using a cloud computing system that manages the use of a set of remote printers by a set of users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating use of a printing system, comprising:
identifying a custom sound associated with a user of the printing system; and
providing the custom sound to a printer in the printing system, wherein the printer generates the custom sound to facilitate identification of the printer by the user.

2. The computer-implemented method of claim 1, wherein identifying the custom sound involves at least one of:
obtaining a selection of the custom sound from the user;
obtaining the custom sound from user data for the user; and
obtaining an identifier for the custom sound.

3. The computer-implemented method of claim 2, wherein the identifier is associated with at least one of a print job, the user, a device, a document to be printed, and a group.

4. The computer-implemented method of claim 1, wherein providing the custom sound to the printer involves at least one of:
providing audio data for the custom sound to the printer; and
providing an identifier for the custom sound to the printer.

5. The computer-implemented method of claim 4, wherein the audio data for the custom sound is provided by at least one of a print server in the printing system, a device in the printing system, storage on the printer, and a network associated with the printing system.

6. The computer-implemented method of claim 1, wherein the custom sound is generated during at least one of:
receipt of a print job by the printer;
completion of the print job;
a job error associated with the print job; and
use of the printing system by the user.

7. The computer-implemented method of claim 1, wherein the custom sound comprises a ringtone.

8. A computer-implemented method for facilitating use of a printer, comprising:
obtaining, at the printer, a custom sound associated with a user; and
generating the custom sound at the printer, wherein the custom sound facilitates identification of the printer by the user.

9. The computer-implemented method of claim 8, wherein the custom sound is obtained with a print job associated with the user.

10. The computer-implemented method of claim 8, wherein obtaining the custom sound involves at least one of:
receiving audio data for the custom sound; and
receiving an identifier for the custom sound.

11. The computer-implemented method of claim 10, wherein the audio data is obtained from at least one of a print server, a device, storage on the printer, and a network associated with the printer.

12. The computer-implemented method of claim 8, wherein the custom sound is generated during at least one of:
receipt of a print job by the printer;
completion of the print job;
a job error associated with the print job; and
use of the printer by the user.

13. The computer-implemented method of claim 8, wherein the custom sound comprises a ringtone.

14. A system for facilitating use of a printing system, comprising:
a print server configured to:
identify a custom sound associated with a user of the printing system; and
provide the custom sound to a printer in the printing system; and
the printer configured to generate the custom sound, wherein the custom sound facilitates identification of the printer by the user.

15. The system of claim 14, wherein identifying the custom sound involves at least one of:
obtaining a selection of the custom sound from the user;
obtaining the custom sound from user data for the user; and
obtaining an identifier for the custom sound.

16. The system of claim 14, wherein providing the custom sound to the printer involves at least one of:
providing audio data for the custom sound to the printer; and
providing an identifier for the custom sound to the printer.

17. The system of claim 16, wherein the audio data for the custom sound is provided by at least one of the print server, a device in the printing system, storage on the printer, and a network associated with the printing system.

18. The system of claim 14, wherein the custom sound is generated during at least one of:
receipt of a print job by the printer;
completion of the print job;
a job error associated with the print job; and
use of the printing system by the user.

19. The system of claim 14, wherein the printer is associated with a printing pool in the printing system.

20. A computer-readable storage medium storing instructions that when executed by a computer cause the computer to perform a method for facilitating use of a printing system, the method comprising:
identifying a custom sound associated with a user of the printing system; and
providing the custom sound to a printer in the printing system, wherein the printer generates the custom sound to facilitate identification of the printer by the user.

21. The computer-readable storage medium of claim 20, wherein identifying the custom sound involves at least one of:
obtaining a selection of the custom sound from the user;
obtaining the custom sound from user data for the user; and
obtaining an identifier for the custom sound.

22. The computer-readable storage medium of claim 20, wherein enabling generation of the custom sound at the printer involves at least one of:
providing audio data for the custom sound to the printer; and
providing an identifier for the custom sound to the printer.

23. The computer-readable storage medium of claim 22, wherein the audio data for the custom sound is provided by at least one of a print server in the printing system, a device in the printing system, storage on the printer, and a network associated with the printing system.

24. The computer-readable storage medium of claim 20, wherein the custom sound is generated during at least one of:
receipt of a print job by the printer;
completion of the print job;
a job error associated with the print job; and
use of the printing system by the user.

25. The computer-readable storage medium of claim 20, wherein the custom sound comprises a ringtone.
